(19) United States
(12) Patent Application Publication
(10) Pub. No.: US 2013/0189722 A1
(43) Pub. Date: Jul. 25, 2013

(54) ISOLATION OF PELLET-FORMING MICROORGANISMS

(71) Applicants: Joshua Trueheart, Concord, MA (US); Jefferson Clay Lievense, Kensington, CA (US); Sara Iverson, Lexington, MA (US)

(72) Inventors: Joshua Trueheart, Concord, MA (US); Jefferson Clay Lievense, Kensington, CA (US); Sara Iverson, Lexington, MA (US)

(21) Appl. No.: 12/676,622

(22) PCT Filed: Sep. 5, 2008
(86) PCT No.: PCT/US2008/075352

§ 371 Date: Sep. 9, 2010

Related U.S. Application Data
(60) Provisional application No. 60/970,101, filed on Sep. 5, 2007.

(51) Int. Cl. G01N 21/64

(52) U.S. Cl. CPC G01N 21/6486
USPC 435/29; 435/254.1; 435/252.1

(57) ABSTRACT

The present disclosure provides technologies for identifying, characterizing and/or sorting pellet-forming microorganisms such as bacteria and/or fungi (e.g., yeast) in liquid culture, and particularly under fermentation conditions. In some embodiments, the pellet-forming microorganisms produce one or more commercial products. For example, in some embodiments the pellet-forming microorganisms produce one or more organic acids, carotenoid compounds, essential fatty acids, industrial enzymes, active pharmaceuticals, extracellular carbohydrates, and insecticidal compounds, etc. In many embodiments, the organisms are sorted while in their pellet form.

### RELATED APPLICATIONS

This application claims the benefit of U.S. Provisional Application No. 60/970,101, filed Sep. 5, 2007, the contents of which are hereby incorporated by reference in their entirety.

### BACKGROUND

A huge percentage of biological research is performed on a small number of model organisms that have proven to be experimentally tractable. However, as the field of industrial biotechnology continues to develop, there is an increasing desire to harness the characteristics of different microorganisms. There is a need in the field for the development of improved techniques for handling microorganisms with more complex growth characteristics, such as growth characteristics that are not typically encountered during routine laboratory cultivation.

For example, most microbial organisms typically used in the biotechnology industry (e.g., planktonic microorganisms) grow as simple, uninuclear cells. However, many organisms that produce industrially relevant compounds have more complicated biology. For instance, many such organisms are naturally filamentous, and may grow in pellet form. Filamentous organisms that grow in pellet form are generally not amenable to many standard methods applied to planktonic microorganisms that grow as single uninuclear cells. Among other things, the filamentous morphology generates significant viscosity and limits mass transfer of nutrients and oxygen. Furthermore, the pellet formed by such organisms can be comprised of a number of cells that may represent a heterogeneous population with respect to growth stage and/or metabolic activity. Thus, such pellet-forming microorganisms, although they may display certain intriguing production characteristics, also present technological challenges. There is a need therefore for the development of techniques for handling microorganisms (e.g., filamentous fungi and bacteria) that may grow in pellet form. There is a particular need to develop techniques that can identify desirable microorganisms within a complex population of microorganisms and/or in a physiological context, such as growth in the pellet form, that is expected to be reflective of performance in industrial scale fermentations.

### SUMMARY

The present disclosure provides technologies for handling and analyzing pellet-forming microorganisms, and microorganisms produced by the technologies. The present disclosure particularly provides systems for identifying variants of pellet-forming microorganisms and/or for sorting pellet-forming microorganisms. In particular, the present disclosure provides methods for physically sorting pellet-forming microorganisms on the basis of one or more optically detectable properties (e.g., size, optical density, presence and/or intensity of fluorescent emission, autofluorescence, etc.).

In certain embodiments of the disclosure, pellet-forming microorganisms are sorted during and/or after growth in liquid culture. This offers many advantages over sorting (e.g., screening and/or selection) schemes that utilize growth on solid or other media, as such schemes may not reflect the behavior of the microorganisms under fermentation conditions. In some embodiments, the present disclosure allows identification, analysis, and/or sorting of pellet-forming microorganisms under growth conditions similar or identical to fermentation conditions, for example to fermentation conditions utilized so that the microorganisms produce a particular product. In many embodiments, pellet-forming microorganisms are sorted while in their pellet form. In some embodiments, at least some pellet-forming microorganisms are harvested from a collection produced by sorting.

In certain embodiments of the present disclosure, a sample to be characterized and/or sorted includes a genetically diverse population of microorganisms. In some embodiments, individual microorganisms within such a genetically diverse population are related to one another as progeny of a parent microorganism that has been exposed to a mutagenic protocol.

In some embodiments, a sample to be characterized and/or sorted includes one or more microorganisms that produce(s) a product. For example, in some embodiments, such a sample includes one or more microorganisms that produce one or more organic acids, carotenoid compounds, essential fatty acids, industrial enzymes, active pharmaceuticals, extracellular carbohydrates, insecticidal compounds, etc.

In some embodiments of the present disclosure, pellet-forming microorganisms in liquid suspension are sorted by application of a pulse of air that diverts fluid flow; in some embodiments, pellet-forming microorganisms in liquid suspension are sorted by changing collection chambers without necessarily altering fluid flow trajectory.

### DESCRIPTION OF THE DRAWING

FIG. 1 is reproduced from FIG. 1 of U.S. Pat. No. 6,400,453 and presents a highly schematic representation of a particular flow cytometer system that can be utilized to identify, analyze, and/or sort pellet-form microorganisms in accordance with the present disclosure.

FIG. 2 is an autofluorescence spectra, as detected by fluorimeter, for strain 2 pellets of varying ages. Top: excitation at 488 nm; bottom: 350 nm. The 18 hr results are skewed by low pellet numbers.

FIG. 3 is a scatter plot of peak heights (PH) for 2, 3, and 4 day autofluorescence (combined in silico). dark grey: 2 days old; black: 3 days; light grey: 4 days.

### DEFINITIONS

Carotenoid compound: A “carotenoid compound”, as that term is used herein, refers to a compound derived from isoprenoid pathway intermediates. The commitment step in carotenoid biosynthesis is the formation of phytoene from geranylgeranyl pyrophosphate. Carotenoids can be acyclic or cyclic, and may or may not contain oxygen, so that the term carotenoid compounds includes both carotenes and xanthophylls. In general, carotenoids are hydrocarbon compounds having a conjugated polyene carbon skeleton formally derived from the five-carbon compound isopentyl pyrophosphate (IPP), including triterpenes (C₃₀ diapocarotenoids) and tetraterpenes (C₄₀ carotenoids) as well as their oxygenated derivatives and other compounds that are, for example, C₃₅, C₅₀, C₆₀, C₇₀, C_{go} in length or other lengths. Many carotenoids have strong light absorbing properties and may range in length in excess of C₂₀₀. C₃₀ diapocarotenoids typically consist of six isoprenoid units joined in such a manner that the arrangement of isoprenoid units is reversed at the center of the molecule so that the two central methyl groups are in a 1,6-positional relationship and the remaining non-terminal methyl groups are in a 1,5-positional relationship. Such C₃₀ carotenoids may be formally derived from the acyclic C₃₀H₄₂ structure, having a long central chain of conjugated double bonds, by: (i) hydrogenation (ii) dehydrogenation, (iii) cyclization, (iv) oxidation, (v) esterification/glycosylation, or any combination of these processes. C₄₀ carotenoids typically consist of eight isoprenoid units joined in such a manner that the arrangement of isoprenoid units is reversed at the center of the molecule so that the two central methyl groups are in a 1,6-positional relationship and the remaining non-terminal methyl groups are in a 1,5-positional relationship. Such C₄₀ carotenoids may be formally derived from the acyclic C₄₀H₅₆ structure, having a long central chain of conjugated double bonds, by (i) hydrogenation, (ii) dehydrogenation, (iii) cyclization, (iv) oxidation, (v) esterification/glycosylation, or any combination of these processes. The class of C₄₀ carotenoids also includes certain compounds that arise from rearrangements of the carbon skeleton, or by the (formal) removal of part of this structure. More than 600 different carotenoids have been identified in nature; carotenoids include but are not limited to: antheraxanthin, adonirubin, adonixanthin, astaxanthin, canthaxanthin, capsorubrin, β-cryptoxanthin, α-carotene, β-carotene, β,ψ-carotene, δ-carotene, ε-carotene, echinenone, 3-hydroxyechinenone, 3′-hydroxyechinenone, γ-carotene, ψ-carotene, 4-keto-γ-carotene, ξ-carotene, α-cryptoxanthin, deoxyflexixanthin, diatoxanthin, 7,8-didehydroastaxanthin, didehydrolycopene, fucoxanthin, fucoxanthinol, isorenieratene, β-isorenieratene, lactucaxanthin, lutein, lycopene, myxobactone, neoxanthin, neurosporene, hydroxyneurosporene, peridinin, phytoene, phytofluene, rhodopin, rhodopin glucoside, 4-keto-rubixanthin, siphonaxanthin, spheroidene, spheroidenone, spirilloxanthin, torulene, 4-keto-torulene, 3-hydroxy-4-keto-torulene, uriolide, uriolide acetate, violaxanthin, zeaxanthin-β-diglucoside, zeaxanthin, and C₃₀ carotenoids. Additionally, carotenoid compounds include derivatives of these molecules, which may include hydroxy-, methoxy-, oxo-, epoxy-, carboxy-, or aldehydic functional groups. Further, included carotenoid compounds include ester (e.g., glycoside ester, fatty acid ester) and sulfate derivatives (e.g., esterified xanthophylls).

Commercial product: As used herein, a “commercial product” is a product that is sold in commerce.

Commercially relevant fermentation product: As used herein, the phrase “commercially relevant fermentation product” refers to a compound or other agent that is produced by fermentation of a filamentous organism and is useful in production of a commercial product. In some embodiments of the disclosure, the compound or other agent itself, and/or the cell that produces it, is a commercial product; in some embodiments, a compound or other agent is derivatized to generate a commercial product; in some embodiments, a compound or other agent, derivative thereof, and/or producing cell, is combined together with one or more other ingredients or components, to generate a commercial product. To give but a few examples, compounds, agents, derivatives and/or cells may be combined with other ingredients or components to produce, for example, laundry and dishwashing detergents, foods and animal feeds, baked goods, lens cleaners, cosmetics, surfactants, solvents, fibers, flocculants for waste water treatment, gums for industrial and food applications, bacteriostatic agents in a variety of applications, soaps, shampoos, papers, and coatings, among others.

Derivative: The term “derivative” as used herein means a compound whose structure is closely related to that of the parent compound of which it is a “derivative” and that can be produced from the parent molecule by any number of processes including physical treatments, fermentation, biocatalysis, chemical transformation and combinations thereof. To give but a few examples, exemplary derivatives of organic acids include hydrogenated forms of the compounds and/or esters (e.g., dibasic esters) and diamines of organic acids. Also, in some embodiments, polymers of organic acids, including biodegradable polymers (see for example Zeikus et al. (1999) Appl Microbiol Biotechnol 51: 545-552 which is hereby incorporated by reference in its entirety), are considered to be derivatives of organic acids. Particular compounds that are considered to be derivatives of organic acids according to the present disclosure include, for example, tetrahydrofuran (THF), butanediol (e.g. 1,4-butanediol), γ-butyrolactone, pyrrolidinones (e.g. N-methyl-2-pyrrolidone), 4,4-Bionelle, hydroxybutyric acid, succindiamide, 1,4-diaminobutane, and succinonitrile, hydroxybutyrolactone, hydroxysuccinate, adipic acid, and unsaturated succinate derivatives. Exemplary “derivatives” of carotenoid compounds include, but are not limited to, glycoside and fatty acid esters of carotenoids and oil emulsions containing carotenoid compounds. Exemplary “derivatives” of fatty acids include, but are not limited to, esters of fatty acids such as biological oils (e.g. triglycerides). To give but a few examples, exemplary “derivatives” of extracellular carbohydrates include, but are not limited to, modified polysaccharides containing one or more than one of β1→4-linked sugars (e.g. hexoses, pentoses), β1→4-linked amino sugars (e.g. glucosamine, galactosamine, N-acetylglucosamine), or covalently linked (e.g. β1→3, β1→6) sugar-containing side chains. Exemplary “derivatives” of industrial enzymes typically are proteins that share significant sequence identity with the parent enzyme and particularly include a set of shared characteristic sequence elements. In many embodiments, a derivative of an industrial enzyme will include at least about 60%, 65%, 70%, 75%, 80%, 85%, 90%, 95%, 96%, 97%, 98%, 99%, or more overall sequence identity and further more will include at least one characteristic sequence element comprising a stretch of at least 5-15 amino acids that shows at least about 95%, 96%, 97%, 98%, 99%, or 100% identity with the parent enzyme. Typically, the characteristic sequence element will include a plurality of residues involved in catalysis. An exemplary “derivative” of an active pharmaceutical ingredient is a pro-drug of the active form of the compound.

Fermentation Conditions: “Fermentation conditions”, as that term is used herein, refers to defined parameters utilized in liquid growth of pellet-forming organisms. Specific parameters that contribute to fermentation conditions include, but are not limited to, medium composition (including substances such as surfactants and particulate materials, identity of carbon source, etc), pH, temperature, duration of culturing, aeration and/or mechanical agitation, and inoculum quantity and form (e.g. spores or vegetative culture). In many embodiments, fermentation conditions are designed and/or selected to promote the accumulation of one or more desired fermentation products such as one or more organic acids, carotenoid compounds, fatty acids, extracellular carbohydrates, industrial enzymes, active pharmaceutical ingredients, or insecticidal compounds. In many embodiments, fermentation conditions used for sorting are substantially identical to those used for industrial production of a particular commercially relevant fermentation product.

Genetically Engineered: A microorganism that has been “genetically engineered”, as that term is used herein, is one whose genetic material has been manipulated by the hand of man. Homogeneous: As used herein, “homogeneous” and “homogeneity” refer to how closely clustered are the values determined for a given parameter analyzed from a set of fungal pellets. Homogeneity can be determined by assessing the standard deviation of a sample set. In comparing different sample sets, a smaller standard deviation value indicates greater homogeneity. Standard deviation can be determined for a sample set, wherein the number of samples in the set provides a confidence level of at least 90%, and in many cases at least 95%, in the determination. Typically, at least 3 samples can be used. Where multiple samples sets are used, e.g., both a control sample set and a test sample set, each set can contain the same number of samples, e.g., at least 3 samples each.

Improved size and Improved density: As used herein, an “improved size” refers to a finding that fungal pellets of a treated sample set, in comparison to those of a control sample set, exhibit an increased proportion of pellets whose diameter is from 100-175 microns, and, when comparing multiple fungal pellet sample sets that both exhibit about the same percentage of pellets falling within this range, that further exhibit a more homogeneous pellet diameter throughout the sample population. The diameter measured for each pellet can be the major diameter or a representative or approximate average diameter thereof.

As used herein, an “improved density” refers to a finding that fungal pellets of a treated sample set, in comparison to those of a control sample set, exhibit an increased proportion of pellets whose optical density falls within a range of 33-100% of the maximum optical density found for pellets in the sample population, and, when comparing multiple fungal pellet sample sets that both exhibit about the same percentage of pellets falling within this range, that further exhibit a more homogeneous optical density value for pellets throughout the sample population. This is based on optical density measurements for individual pellets. In various embodiments, optical density can be assessed by measuring Extinction, and the relevant comparison window is then 33-100% of maximum Extinction found for pellets in the sample population. Extinction can be measured according to any of various methods known in the art and this can be done by detection of photo-transmission (or absorbance) of the pellets, e.g., densitometry. Any useful wavelength(s) can be employed for this; some useful examples include 515 nm, 545 nm, and 610 nm, and combinations thereof. Extinction can also be measured according to manufacturer's instructions accompanying various analytical instruments, such as the COPAS™ instruments (available from Union Biometrica, Holliston, Mass., USA). Other examples of useful protocols for extinction measurements that can be readily adapted for fungal pellet measurement include those described in: T. Kodadek & K. Bachhawat-Sikder, “Optimized protocols for the isolation of specific protein-binding peptides or peptoids from combinatorial libraries displayed on beads,” Molecular BioSystems 2(1):25ff. (2006); US Patent Publication No. 2007/0298411 to Choo for “Cell Culture” (see Ex. 11); and R. Pulak, “Techniques for Analysis, Sorting, and Dispensing of C. elegans on the COPAS™ Flow-Sorting System,” in K. Strange (ed.), C. elegans: Methods and Applications, pp. 275-286, in series J. M. Walker (series ed.), Methods in Molecular Biology, vol. 351 (Aug. 15, 2006).

Such size and/or density measurements can be performed mechanically, e.g., by obtaining an optical signal that is proportion to the selected parameter of size or density, although in alternative embodiments visual inspection can be employed. Various analytical techniques and instruments for such optical signal measurements are known from the fields of spectrometry, flow cytometry, and densitometry. In some embodiments, optical signals can be obtained from the pellets without labeling. For example, fungal pellets can be stimulated to emit an inherent fluorescence signal. In other embodiments, labeling, e.g., with dye or other detectable label, can be used, and this can be a fluorescent dye. In order to prepare optical signal data for comparison of sample populations, the data can be first converted to size or density values that are then used in performing the comparison, or the optical signal data can be used therein without prior conversion. The order of such steps is non-limiting in embodiments hereof. In some embodiments hereof, filamentous fungal cells can be employed that are not part of a pellet, but can be part of a hypha, cell agglomerate, or other fungal form, or can be solitary anamorphs; however, in any embodiments in which a cell is described for use herein, the cell can be situated as part of a pellet that is provided, treated to produce treated cells thereof, propagated to produce progeny pellets therefrom, or otherwise manipulated according to the description.

Mutagenic Protocol: A “mutagenic protocol”, as that term is used herein, refers to steps applied to a parent cell or strain to produce progeny cells or strains that contain one or more genetic differences from the parent. In some embodiments, a mutagenic protocol involves introduction of one or more nucleic acids into the progeny cells; in some embodiments, a mutagenic protocol involves application of a chemical or other (e.g., radiation such as UV-radiation, etc.) mutagen to a parent cell or strain; in some embodiments, a mutagenic protocol involves replication of target DNA in a cell with impaired DNA repair enzymes.

Pellet-Forming Microorganism: As used herein, the term “pellet-forming microorganism” is intended to refer to a fungus or bacterium that exhibits pellet-form growth. Typically, a pellet-forming microorganism forms pellets on the order of approximately 75-500 microns in diameter, which may ultimately achieve a pellet size of 1-2 millimeters by the end of fermentation. In many embodiments, a pellet-forming microorganism is a non-coagulative pellet-forming microorganism, meaning that, when cultured under fermentation conditions, its pellets are formed from a single or very small number (e.g., fewer than 5, 4, 3, or 2) of cells rather than from the agglomeration and subsequent growth of a significant number (e.g., greater than 10 or more) of spores and/or hyphae to form clumps. In some embodiments, a single pellet is formed from growth of a single spore. Non-coagulative pellet-forming microorganisms are particularly useful in the practice of the present disclosure because pellets formed from a single spore are genetically homogeneous (i.e., clonal). The present invention encompasses the recognition that the tendency of non-coagulative pellet-forming microorganisms to generate clumps formed from only one spore can be exploited in order to allow separation of genetically distinct progeny cells after mutagenesis of a parent cell. By contrast, if progeny of a mutagenized parent cell form agglomerations or clumps, such agglomerations or clumps typically contain genetically heterogeneous cells, resulting from growth of genetically heterogeneous spores.

### DESCRIPTION OF CERTAIN PREFERRED EMBODIMENTS

As described herein, the present disclosure provides methodologies for identifying, categorizing, and/or physically sorting pellet-forming microorganisms based on an optically detectable property.

### Pellet-Forming Microorganisms

The strategies of the present disclosure are applicable to any pellet-forming microorganism. In many embodiments, these techniques are applied to pellet-forming bacteria and/or to pellet-forming fungi (e.g., filamentous fungi). In some embodiments, the pellet-forming microorganisms are unicellular; in some embodiments, the pellet-forming microorganisms are multicellular. In some embodiments of the present disclosure, a mixture of pellet-forming microorganisms to be sorted includes both unicellular and multicellular organisms. In some embodiments, individual cells of a pellet-forming microorganism may be multinucleate.

For example, pellet-forming microorganisms that may be utilized in accordance with the present disclosure include, for example, filamentous fungi and filamentous bacteria.

Representative filamentous fungi include, but are not limited to, filamentous fungi of the genus Acremonium, Aspergillus, Blakeslea, Emericella, Fusarium, Mortierella, Mucor, Nodulisporium, Paecilomyces, Penicillium, Phycomyces, Rhizopus, or Trichoderma. In some embodiments, the present disclosure utilizes filamentous fungi of the species Aspergillus niger, Aspergillus oryzae, Aspergillus terreus, Mortierella alpina, Paecilomyces sp, Rhizopus oryzae, or Trichoderma reesei.

Representative filamentous bacteria include, but are not limited to, filamentous bacteria of the genus Actinosynnema, Amycolaptopsis, Nocardia, Rhodococcus, Saccharomonospora, Saccharopolyspora, or Streptomyces. In some particular embodiments, the present disclosure utilizes filamentous bacteria of the species Actinosynnema pretiosum, Amycolatopsis orientalis, Nocardia farcinica, Rhodococcus erythropolis, Saccharopolyspora erythraea, Streptomyces avermitilis, Streptomyces clavuligerus, Streptomyces coelicolor, Streptomyces fradiae, Streptomyces griseus, Streptomyces hygroscopicus, Streptomyces lividans, Streptomyces tsukubaensis, or Streptomyces venezuelae.

In general, the present disclosure is particularly applicable to sorting samples containing genetically diverse microorganisms. In some embodiments of the present disclosure, utilized pellet-forming microorganisms are wild type form. It will be appreciated by those of ordinary skill in the art that the wild-type form need not be homogeneous (e.g., clonal); in some embodiments of the present invention, therefore, a wild type sample that comprises natural heterogeneity is sorted. In many embodiments, however, the sample to be sorted includes at least some microorganisms that have been genetically engineered. In some embodiments, a sample to be sorted contains microorganisms related as progeny produced through application of a mutagenic protocol to a parent microorganism.

In some embodiments of the present disclosure, at least some of the microorganisms in a sample to be analyzed and/or sorted as described herein produce at least one commercially relevant fermentation product (including, for example, precursors of or intermediates to commercial products or components thereof). In some embodiments, a sample includes genetically diverse microorganisms that differ in their ability to produce the fermentation product(s). For example, in some embodiments, a sample includes both a parent microorganism and at least one progeny microorganism generated through application of a mutagenic protocol, wherein the progeny microorganism differs from the parent in its ability to produce the fermentation product (e.g., the parent microorganism does not produce the product, or the progeny produces more of the product than the parent microorganism under identical fermentation conditions).

For example, representative commercially relevant fermentation products that may be produced by microorganisms utilized in accordance with the present disclosure include, but are not limited to, organic acids, carotenoid compounds, essential fatty acids, industrial enzymes, active pharmaceutical ingredients, extracellular carbohydrates, insecticidal compounds, derivatives thereof, etc., and combinations thereof.

Exemplary organic acids that may be produced as described herein include, for example, C2-C6 mono- and di-carboxylic acids, C3-C6 tri-carboxylic acids, acetic acid, butyric acid, citraconic acid, citric acid, fumaric acid, glycolic acid, hydroxybutyric acid, isocitric acid, itaconic acid, lactic acid, maleic acid, malic acid, malonic acid, oxaloacetic acid, propionic acid, pyruvic acid, succinic acid, tartaric acid, tartronic acid, tricarballylic acid, derivatives thereof, and combinations of any of the foregoing.

Exemplary carotenoid compounds that may be produced as described herein include, for example, astaxanthin, beta-carotene, canthaxanthin, lycopene, lutein, phytoene, phytofluene, zeaxanthin, derivatives thereof, and combinations of any of the foregoing.

Exemplary essential fatty acids that may be produced as described herein include, for example, linoleic acid (e.g. conjugated linoleic acid), arachidonic acid (ARA), docosahexaenoic acid (DHA), eicosapentaenoic acid (EPA), derivatives thereof, and combinations of any of the foregoing.

Exemplary industrial enzymes that may be produced as described herein include, for example, carbohydrates, including but not limited to alpha-amylase, β-amylase, cellulase, β-glucanase, β-glucosidase, dextranase, dextrinase, alpha-galactosidase (melibiase), glucoamylase, hemicellulase, invertase, laccase, naringinase, pentosanase, pectinase, pullulanase, and xylanase; proteases, including but not limited to, trypsin, acid proteinase, alkaline protease, bromelain, and pepsin; peptidases, including but not limited to, aminopeptidase, endo-peptidase, and subtilisin; lipases and esterases, including but not limited to, aminocyclase, glutaminase, lysozyme, penicillin acylase, and isomerases; oxidoreductases, including but not limited to, alcohol dehydrogenase, amino acid oxidase, catalase, chloroperoxidase, and peroxidase; lyases, including but not limited to, acetolactate decarboxylase, aspartic β-decarboxylase, and histidase; transferases, including but not limited to, cyclodextrin glycosyltransferase; phytases; derivatives thereof, and combinations of any of the foregoing.

Exemplary active pharmaceutical ingredients that may be produced as described herein include, for example, metabolites, e.g., cytotoxic metabolites, e.g., anti-bacterial agents. An “anti-bacterial” is a molecule that has cytocidal or cytostatic activity against some or all bacteria. Anti-bacterials include, without limitation, β-lactams; β-lactamase inhibitors such as clavulanic acid; aminoglycosides such as gentamycin, neomycin, streptomycin and tobramycin; ansamycins such as geldanamycin, rifamycin, and ansamitocin; glycopeptides such as teicoplanin and vancomycin; macrolides such as erythromycin, azithromycin, and clarithromycin; polypeptides such as bacitracin, colistin and polymyxin B; and tetracyclines such as doxycycline, minocycline, and oxytetracycline. β-lactams include, without limitation, penicillins and cephalosporins and biosynthetic intermediates thereof. Penicillins and biosynthetic intermediates include, without limitation, isopenicillin N,6-aminopenicillanic acid (6-APA), penicillin G, penicillin N, and penicillin V. Cephalosporins and biosynthetic intermediates include, without limitation, deacetoxycephalosporin V (DAOC V), deacetoxycephalosporin C (DAOC), deacetylcephalosporin C (DAC), 7-aminodeacetoxycephalosporanic acid (7-ADCA), cephalosporin C, 7-B-(5-carboxy-5-oxopentanamido)-cephalosporanic acid (keto-AD-7ACA), 7-B-(4-carboxybutanamido)-cephalosporanic acid (GL-7ACA), and 7-amino cephalo sporanic acid (7ACA).

In certain embodiments of the disclosure, the active pharmaceutical ingredient is an anti-hypercholesterolemic or a biosynthetic intermediate thereof. An “anti-hypercholesterolemic” is a drug administered to a patient diagnosed with elevated cholesterol levels, for the purpose of lowering the cholesterol levels. Anti-hypercholesterolemics include statins, which include, without limitation, atorvastatin, rosuvastatin, fluvastatin lovastatin, mevastatin (compactin), simvastatin, cerivastatin, pitavastatin, and pravastatin.

In certain embodiments of the disclosure, the active pharmaceutical ingredient is an immunosuppressant or a biosynthetic intermediate thereof. An “immunosuppressant” is a molecule that reduces or eliminates an immune response in a host when the host is challenged with an immunogenic molecule, including immunogenic molecules present on transplanted organs, tissues or cells. Immunosuppressants include, without limitation, members of the cyclosporin family, mycophenolic acid, rapamycin, tacrolimus, sirolimus and beauverolide L. Cyclosporins include, without limitation, cyclosporin A and cyclosporin C.

In certain embodiments of the disclosure, the active pharmaceutical ingredient is an ergot alkaloid or a biosynthetic intermediate thereof. An “ergot alkaloid” is a member of a large family of alkaloid compounds that are most often produced in the sclerotia of fungi of the genus Claviceps. An “alkaloid” is a small molecule that contains nitrogen and has basic pH characteristics. The classes of ergot alkaloids include clavine alkaloids, lysergic acids, lysergic acid amides, and ergot peptide alkaloids. Ergot alkaloids include, without limitation, ergotamine, ergosine, ergocristine, ergocryptine, ergocornine, ergotaminine, ergosinine, ergocristinine, ergocryptinine, ergocorninine, ergonovine, ergometrinine, and ergoclavine.

In certain embodiments of the disclosure, the active pharmaceutical ingredient is an inhibitor of angiogenesis or a biosynthetic intermediate thereof. An “angiogenesis inhibitor” is a molecule that decreases or prevents the formation of new blood vessels. Angiogenesis inhibitors have proven effective in the treatment of several human diseases including, without limitation, cancer, rheumatoid arthritis, and diabetic retinopathy Inhibitors of angiogenesis include, without limitation, fumagillin and ovalicin.

In certain embodiments of the disclosure, the active pharmaceutical ingredient is a glucan synthase inhibitor or a biosynthetic intermediate thereof. A “glucan synthase inhibitor” is a molecule that decreases or inhibits the production of 1,3-β-D-glucan, a structural polymer of fungal cell walls. Glucan synthase inhibitors are a class of antifungal agents. Preferred glucan synthase inhibitors include, without limitation, echinocandin B, pneumocandin B, aculeacin A, and papulacandin.

In certain embodiments of the disclosure, the active pharmaceutical ingredient is an anti-neoplastic compound or a biosynthetic intermediate thereof. An “anti-neoplastic” compound is a molecule that prevents or reduces tumor formation. Anti-neoplastic compounds include, without limitation, taxol (paclitaxel) and related taxoids.

Exemplary insecticidal compounds include, but are not limited to, avermectin and nodulisporic acid.

Exemplary extracellular carbohydrates that may be produced as described herein include, for example, chitin, chitosan, N-acetylglucosamine, glucosamine, polygalactosamine, pullulan, scleroglucan, derivatives thereof, and combinations of any of the foregoing.

Typically, pellet-forming microorganisms for use in accordance with the present disclosure are grown under conditions that support pellet-form growth, such that the sample that is analyzed includes organisms in pellet form. As will be appreciated by those of ordinary skill in the art, a variety of different parameters can impact whether and to what extent a particular microorganism grows in a pelleted or mycelial form. Furthermore, by varying one or more of these fermentation condition parameters, it is possible to impact whether a particular pellet-forming microorganism grows as a non-coagulative pellet-forming microorganism or rather forms clumps as the result of agglomeration of a significant number of spores and/or hyphae.

To give but a few examples, the concentration of the inoculum can profoundly influence both whether a microorganism grows in mycelial form or in pellet form, and further can influence whether it forms non-coagulative pellets clumps. In general, for filamentous organisms, lower concentration inocula are more likely to promote growth in a mycelial form than pellet-form growth. Increased concentrations of inocula are more likely to result in pellet-form growth. In general, extremely high inocula result in clumping, whereas, within a given range of fairly high inocula, it is often possible to promote non-coagulative pellet-form growth. Those of ordinary skill in the art will appreciate, however, that the absolute amount of inoculum that will promote pellet formation can vary widely across organisms and fermentation processes. For example, in some embodiments, pellets are formed over a spore concentration range of about 1.0×10⁴ to about 1.0×10⁶ spores/ml.

Other parameters that can affect pellet form growth include, for example, medium composition (including the presence or absence of substances such as specific cations, surfactants, and particulate materials and/or identity of carbon source), pH, temperature, duration of culturing, presence and/or degree of aeration and/or mechanical agitation.

Conditions that support pellet-form growth, particularly of filamentous microorganisms are well known in the art and are described, for example, in Appl Biochem Biotechnol. 2006 September; 134(3):249-62, Appl Biochem Biotechnol. 2006 Spring; 129-132:844-53, J Eukaryot Microbiol. 2006 May-June; 53(3):199-203, Microbiol Res. 2005; 160(4):375-83, Biotechnol Prog. 2005 September-October; 21(5):1389-400, Biotechnol Bioeng. 2005 Dec. 5; 92(5):614-23, J Ind Microbiol Biotechnol. 2005 June; 32(6):227-33, Appl Microbiol Biotechnol. 2005 August; 68(3):305-10, J Biotechnol. 2005 Mar. 2; 116(1):61-77, J Microbiol. 2004 March; 42(1):64-7, Bioprocess Biosyst Eng. 2004 October; 26(5):315-23, J Appl Microbiol. 2004; 96(6):1296-305, Biotechnol Bioeng. 2004 Jan. 5; 85(1):96-102, J Appl Microbiol. 2003; 94(1):120-6, Curr Microbiol. 2003 January; 46(1):24-7, Appl Microbiol Biotechnol. 2001 June; 55(6):704-11, Appl Microbiol Biotechnol. 2001 July; 56(1-2):88-92, Appl Biochem Biotechnol. 2000 Spring; 84-86:779-89, Biotechnol Prog. 2000 March-April; 16(2):222-7, Biotechnol Bioeng. 1999 May 20; 63(4):442-8, Biotechnol Bioeng. 1998 Oct. 20; 60(2):216-29, Biotechnol Bioeng. 1998 Jun. 5; 58(5):478-85, Enzyme Microb Technol. 1996 September; 19(4):261-6, Biotechnol Prog. 1995 January-February; 11(1):93-8, Appl Microbiol Biotechnol. 1992 May; 37(2):157-63, Biotechnol Bioeng. 1977; 19:781-99, and United States Patent Application 20030215950.

### Optical Parameters

As described herein, pellet-form microorganisms may be sorted based on any of a variety of optical parameters. For example, microorganisms may be sorted based on one or more optical parameters selected from the group consisting of size, optical density, presence and/or intensity of fluorescent emission, etc., and combinations thereof.

When microorganisms are sorted based on size, the microorganisms are sorted for a defined axial length which is defined by the time of flight of a single pellet across a fixed sensing zone of a flow cell. In brief, pellets are individually passed through the focus of a laser beam, and signals are recorded by a forward scatter detector and fluorescence detectors. Relative size, or time of flight (TOF), is measured by an axial light-loss detector, which records the time that the light blockage signal remains above a pre-set threshold level.

Sorting by pellet size is desirable, among other things, because pellet size can impact industrial scale fermentations in several manners, including but not limited to, altering oxygen transfer properties across both the entire culture and different regions of a given pellet and altering the energy requirements and cost for physically stirring and/or aerating the culture. Size can also be used as a readout for desirable properties, including but not limited to, enhanced ability to utilize a specific or complex substrate or the enhanced resistance of a given pellet to harsh culture conditions such as extreme pH (e.g., low or high pH), high osmolarity of either carbon source or fermentation product, presence of toxic product or biosynthetic intermediate or by-product, etc.

When microorganisms are sorted based on optical density of pellets, the optical density of a pellet, or optical extinction, is determined by the total integrated signal of the light blockage (as determined by an axial light-loss detector).

Sorting by optical density of pellets is desirable because, among other things, pellet optical density, like pellet size, can also impact industrial scale fermentation and can be a readout for other desirable (or undesirable) characteristics.

When microorganisms are sorted based on fluorescence, the fluorescence intensity can be simultaneously determined at one or more than one different wavelengths by excitation and emission filters. The relevant fluorescent emission may represent autofluorescence of the microorganisms or may alternatively (or additionally) reflect fluorescence of a particular fluorescent label associated with one or more of the microorganisms. For example, in some embodiments, a sample of microorganisms is contacted with a reagent that is covalently associated with a fluorescent label and that binds non-covalently (directly or indirectly) with one or more microorganism components. To give but one example, in some embodiments, a sample of microorganisms is contacted with a labeled antibody that binds specifically with one or more microorganism markers that may be expressed on or produced by only some of the microorganisms within a sample.

In some embodiments, a fluorescent label is associated with the exterior of a microorganism (e.g., via interaction with a cell surface component); in some embodiments, a fluorescent label is associated with the interior of a microorganism (e.g., having been taken up by metabolizing or replicating cells, etc.). In some embodiments, a fluorescent label is associated with both the interior and the exterior of a microorganism.

In some embodiments, a sample of microorganisms contains more than one potential source of fluorescent emission. In some cases, a sample of microorganisms contains more than one fluorescent label. In some embodiments, fluorescence (and/or intensity) of more than one fluorophore is monitored and may provide a basis for sorting. In some embodiments, fluorescence intensity at one or more wavelengths is monitored in combination with size and/or optical density of the pellet-forming microorganism.

To give but a few specific examples of sources of fluorescent emission that may be utilized in accordance with the present disclosure, in some embodiments, the source of fluorescent emission may be a fluorescent dye that is an analog or derivative of a carbohydrate used for the cultivation of pellet-form microorganisms. In some such embodiments, the analog or derivative of a carbohydrate is an analog or derivative of glucose such as, for example, 2-NBDG (2-(N-(7-nitrobenz-2-oxa-1,3-diazol-4-yl)amino)-2-deoxy-D-glucose) or 6-NBDG (6-(N-(7-nitrobenz-2-oxa-1,3-diazol-4-yl)amino)-6-deoxyglucose), or combinations thereof. Such glucose analogs can be employed as indicators of glucose uptake and perhaps overall metabolic activity. For example, pellet-forming microorganisms can be incubated with medium containing the fluorescent glucose (and generally lacking non-labelled glucose), then rinsed of the fluorescent medium and analyzed for fluorescent emission. Pellet-forming microorganisms that exhibit specific fluorescent intensities can be identified followed by excitation and emission at specific wavelengths (e.g. excitation at 488 nm and emission at 545 nm).

In some embodiments, the source of fluorescent emission may be a fluorescent dye that is an indicator of viability of pellet-form microorganisms. In some such embodiments, the indicator of viability is selected from the group consisting of acridine orange, FUN1 (2-chloro-4-(2,3-dihydro-3-methyl-(benzo-1,3-thiazol-2-yl)-methylidene)-1-phenylquinolinium iodide), neutral red, propidium iodide, resazurin, trypan blue, and combinations thereof. As an example, FUN1 is a dye that forms red intravacuolar structures in live cells of many species of fungi. Both living and dead cells take up the FUN1 fluorescent probe when the plasma membrane is intact, and this dye is first seen as a diffuse green fluorescence in the cytosol of both live and dead cells. Subsequently, in metabolically active cells, FUN1 is transported into the vacuole and converted into red cylindrical intravacuolar structures (CIVS). Pellet-forming microorganisms can be stained with FUN1 and sorted for pellet with the desired level of red fluorescence. The fluorescent intensity is believed to correlate with the metabolic activity of the pellets.

In some embodiments, the source of fluorescent emission may be a fluorescent dye that is an indicator of the intracellular pH of a pellet-form microorganism. In some such embodiments, the indicator of the intracellular pH is selected from the group consisting of SNAFL, SNARF 4F, SNARF 5F, and combinations thereof. SNARF 4F (seminaphthorhodafluor-4F 5-(and -6)-carboxylic acid), which is a fluorinated derivative of C-SNARF-1, and other related dyes (e.g. SNAFL and SNARF 5F) are fluorescent ratiometric probes that allow intracellular pH quantification independent of probe concentration and/or laser intensity. SNARF 4F dye has a pH dependent spectral shift such that it is excited at one wavelength and the emission is measured at two wavelengths. It is assumed that the dye exists as a mixture of two forms, the monoanionic (naphthol) and dianionic (naphtholate) states, between which a pH-sensitive equilibrium is established depending on the acidity or alkalinity of the solution or intracellular milieu. A ratio of fluorescence intensities for the two emission wavelengths is used to determine pH. Dyes that indicate intracellular pH can be useful for staining pellet-forming microorganisms. In some embodiments, a pH indicator can be used to identify pellets capable of maintaining a particular range of intracellular pH, even under conditions such as significant change in extracellular pH (e.g. pH less than 3.0) or the presence of other agents known to impact pH homeostasis (e.g. uncoupling agents).

In some embodiments, the source of fluorescent emission may be a fluorescent dye that is an indicator of mitochondrial activity (e.g., gradients, internal reduction-oxidation state, mass, etc.) of a pellet-forming microorganism. For example, a fluorescent dye may be differentially taken up by a microorganism based on differential chemical and/or potential gradients across a mitochondrial membrane. Alternatively or additionally, a fluorescent dye may be differentially taken up based on a different internal reduction-oxidation state. Yet also, some fluorescent dyes accumulate in the mitochondria based on mitochondrial size and therefore differentially stain microorganisms with different mitochondrial mass. In some embodiments, a fluorescent dye that is an indicator of mitochondrial size and/or activity is selected from the group consisting of MitoTracker Green, MitoTracker Red, rhodamine 123, rhodamine B hexyl ester, SYTO 18, and combinations thereof.

MitoTracker Green and Mitotracker Red are two examples of fluorescent dyes that are sequestered in functioning mitochondria, and therefore the dyes can be employed to estimate mitochondrial size and/or activity. The cell-permeant MitoTracker probes contain a thiol-reactive chloromethyl moiety. Once a MitoTracker probe accumulates in the mitochondria, it can react with accessible thiol groups on peptides and proteins to form an aldehyde-fixable conjugate. Unlike other fluorescent dyes used to estimate mitochondrial size or activity (e.g. rhodamine 123), staining with MitoTracker Green or Red is generally thought to be retained under conditions where the mitochondrial membrane potential has been disturbed. Different chloromethyl moieties on the MitoTracker dyes exhibit different reactivities (and therefore sensitivities to loss of membrane potential). Furthermore, different MitoTracker probes exhibit varying fluorescent properties (e.g. fluorescence in aqueous environments prior to accumulation in mitochondria) and specific probes can also differentially impact specific cellular functions (e.g. respiration) when used to treat intact cells. In some embodiments, a dye that can be sequestered in functioning mitochondria can be used to identify pellets capable of exhibiting a particular range of metabolic activity (e.g. respiration) under specific growth conditions.

In some embodiments, the source of fluorescent emission may be a fluorescent dye that is an indicator of the intracellular lipid or polyhydroxyalkanoate level. In some such embodiments, the fluorescent dye is nile red.

In some embodiments, the source of fluorescent emission may be a fluorescent dye that is an indicator of extracellular carbohydrate levels. For example, in some such embodiments, the dye is a fluorescent conjugate of wheat germ agglutinin, concanavalin A, or calco fluor.

In some embodiments, the source of fluorescent emission may be a fluorescent dye that is an indicator of cytoplasmic membrane potential. For example, in some such embodiments, the dye is DiOC₆, bis-(1,3-dibutylbarbituric acid)trimethine oxonol (DiBAC₄(3)), or combinations thereof. Carbocyanines, such as DiOC₆, are examples of dyes that can be used as indicators of membrane potential in cytoplasmic and other membranes. These cationic dyes accumulate on hyperpolarized membranes and are translocated into the lipid bilayer. Aggregation within the confined membrane interior usually results in decreased fluorescence and absorption shifts, although the magnitude and even the direction of the fluorescence response is strongly dependent on the concentration of the dye and its structural characteristics. In many instances, carbocyanine fluorescence is dependent not only on the membrane potential, but also on cell size. Membrane potential dyes can be utilized to both examine changes in membrane potential as well as to follow significant alterations in membrane levels and/or structure (e.g. apoptosis). In some embodiments, a membrane potential dye can be used to identify pellets that exhibit a specific range of hyperpolarized membranes.

In some embodiments, microorganisms are sorted based on more than one optically detectable parameters, e.g., at least two parameters, e.g., at least two parameters of intensity of fluorescent emission.

### Sorting Pellet-Form Microorganisms Based on Optical Parameters

According to the present disclosure, it is desirable to identify, analyze, and/or sort pellet-forming microorganisms in liquid culture. In many embodiments, it is desirable to sort pellet-forming microorganisms in liquid culture under conditions similar or identical to those used for industrial scale fermentation (e.g., for production of one or more commercially relevant fermentation products). By contrast, many standard techniques for characterizing or sorting (e.g., by screen or selection) microorganisms rely on growth on agar plates (for example that contain an indicator or selector). The present disclosure encompasses the recognition that such techniques suffer from the disadvantage that a microorganism's germination or growth behavior on agar plates may differ substantially from its behavior in liquid culture, and in particular under fermentation conditions.

Those of ordinary skill in the art will appreciate that any of a variety of liquid culture conditions can be employed in the practice of the present invention, and will particularly appreciate those parameters that might be varied in order to achieve conditions appropriate for industrial scale fermentation of a particular organism to produce a particular product. To give but a few examples, temperature, pressure, pH, osmolarity, osmolality, carbon source (e.g., use of glucose or non-glucose carbon sources such as, for example, fructose [e.g., fructose syrup], galactose, glycerol, oils, sucrose, triglycerides, etc), other aspects of medium composition (e.g., including presence, amount, and/or identity of substances such as surfactants and particulate materials, etc.), culture density, culture volume, duration of culturing, aeration and/or mechanical agitation, inoculum quantity and form (e.g. spores or vegetative culture), etc can be adjusted to optimize extent of production, identity or relative amounts of produced products, extent or nature of pellet formation, cost, or other desirable parameter or aspect of industrial processing.

Of course, technologies are available for sorting cells in liquid culture. For example, the fluorescence-activated cell sorter (FACS) is a powerful, useful tool that allows researchers to analyze single cell populations and to sort them based on a particular characteristic. In most such devices, a suspension of single cells is passed by one or more focused lasers that excite fluorescent markers that are present in or on some, but not all, of the cells in the suspension. Fluorescent radiation is then collected and analyzed, so that cells that do or do not have the relevant marker(s) are distinguished from one another. Cells are then sorted through application of an acoustic vibration to the stream, which separates the stream into droplets. An electric charge is then applied to those droplets that contain cells of interest (e.g., that do or do not have a particular marker), as determined in advance by the operator. Charged and uncharged droplets are then diverted toward different collection vials via a static electric field.

Standard FACSs cannot sort pellet-form organisms, however. Among other problems, conventional FACSs cannot handle objects of the size of a typical pellet. Depending on the microorganism, fermentation conditions, and time period of a fermentation, pellet-forming microorganisms typically exhibit a pellet size range between 50 and 2000 microns in diameter. In most embodiments, pellet-forming microorganisms to be sorted range between 75 and 500 microns in diameter. In particular embodiments, pellet-forming microorganisms to be sorted range between 50 and 200 microns in diameter.

The present disclosure encompasses the recognition that pellet-forming microorganisms can be efficiently sorted through use of a flow cytometer that utilizes large bore microfluidics, so that pellet-forming microorganisms can pass through. In some embodiments of the present disclosure, a flow cytometer is utilized that has a micro fluidics bore size capable of sorting pellets within the range of about 100 to 250 microns in diameter. In some embodiments of the present disclosure, a flow cytometer is utilized that has a microfluidics bore size capable of sorting pellets within the range of about 40 to 200 microns in diameter. In some embodiments of the present disclosure, a flow cytometer is utilized that has a microfluidics bore size capable of sorting pellets within the range of about 100 to 600 microns in diameter.

The present disclosure encompasses the recognition that pellet-forming microorganisms can be diverted without use of electric charge, which can potentially damage such microorganisms. In some embodiments, the present disclosure utilizes a flow cytometer that diverts organisms with a fluidic switch comprised of a pulse of air that alters fluid flow.

One particular example of a flow cytometer that utilizes a fluidic switch and can be utilized in accordance with the present disclosure is described in, for example, in one or more of U.S. Pat. No. 6,400,453, U.S. Pat. No. 7,116,407, PCT Patent Application WO 200/36396, PCT Patent Application WO 2002/066960, and/or PCT Patent Application WO 2003/016875, each of which is incorporated herein by reference in its entirety. Exemplary such instruments (e.g., COPAS instruments) are available from Union Biometrica, Inc (Somerville, Mass.). These instruments were designed for application to multicellular test organisms such as nematodes, Drosophila larvae, plant seeds or zebrafish, as well as inanimate objects such as beads; the present inventors demonstrate herein that they can be utilized to sort pellet-forming microorganisms, including bacteria and fungi.

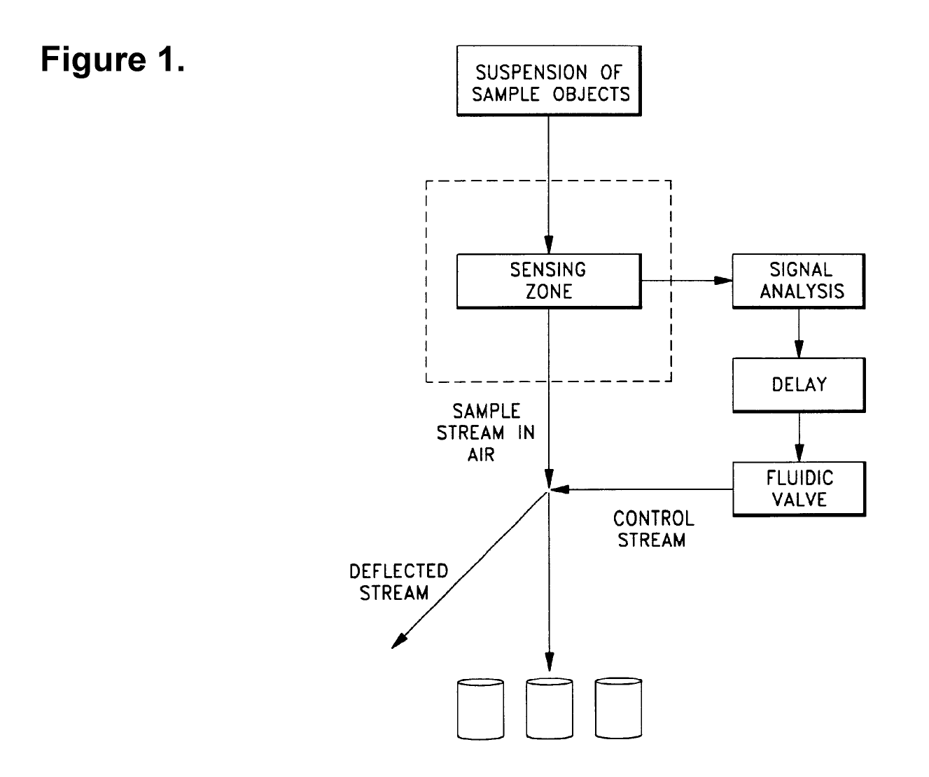

In the Union Biometrica device, items passing through a flow cell are pneumatically diverted by application of a puff of air (see FIG. 1). Specifically, a sample containing objects to be sorted is flowed into a pre-analysis chamber where it is surrounded by a sheath solution to generate a stabilized laminar flow. The sample then flows through a sensing zone, where different lasers can be directed at the sample to excite fluorophores and/or allow measurement of other optical properties (e.g., optical density). Objects that meet specified criteria are flowed into collection vessels, while objects that do not meet the specified criteria are diverted, by application of a puff of air, to a waste or other sample container. The Union Biometrica device typically uses a red diode laser (670 nm) to measure size and/or optical density, and a multi-line argon laser to excite use-selected fluorophores.

In other embodiments, a flow cytometer such as that described in U.S. Pat. No. 6,482,652 can be utilized. In such a flow cytometer fluid flow is not diverted, but rather alternative collection tubes are positioned under the fluid flow stream depending on the classification of items present in the stream. Alternatively or additionally, instruments available from Becton Dickinson and Company, such as the FACStar Plus and/or the FACScaliber, which are available with special flowcells with larger than normal (i.e., approximately 70 micron) flow channels, can be utilized. These instruments are intended for use with samples suspended in water, buffer or biological saline.

In many embodiments, a flow cytometer utilized to identify, analyze, and/or sort pellet-form microorganisms according to the present disclosure includes at least one sensor system that allows detection and/or measurement of at least one optical parameter of pellet-form microorganisms.

For example, in some embodiments, a flow cytometer includes at least one sensor system that allows detection and/or measurement of size and/or optical density of pellet-form microorganisms. In some embodiments, such a sensor system comprises a red diode laser (670 nm) together with a red filter and PIN photodiode detector and a multiline argon laser (488 nm and 514 nm), which are coupled with specific filters and emission detectors. In some embodiments, dsRed (red fluorescent protein), YFP (yellow fluorescent protein), and GFP (green fluorescent protein) filters are used in conjunction with photomultiplier tubes to monitor fluorescent emission at 610 nm, 545 nm, and 510 nm, respectively.

Alternatively or additionally, a flow cytometer for use in accordance with the present disclosure may include at least one sensor system that allows detection and/or measurement of fluorescent radiation associated with pellet-forming microorganisms. Such a sensor system typically includes a laser or other radiation source for exciting particular fluorophores. In many embodiments, such a sensor system includes a plurality of lasers or other radiation sources so that multiple fluorophores can be excited. In some embodiments, a flow cytometer for use in accordance with the present disclosure includes at least one blue/green laser (e.g., one argon laser). In some embodiments, a multi-line argon laser (488 nm and 514 nm) is used in conjunction with specific filters and emission detectors. In some embodiments, dsRed, YFP, and GFP filters are used together with photomultiplier tubes to monitor fluorescent emission at 610 nm, 545 nm, and 510 nm, respectively.

In some embodiments, a flow cytometer for use in accordance with the present disclosure includes at least one sensor system that allows detection and/or measurement of a parameter selected from the group consisting of size, cell density, and combinations thereof, and further includes at least one sensor system that allows detection and/or measurement of fluorescent radiation associated with pellet-forming microorganisms.

### Applications

The present disclosure can be used to identify, analyze, and/or sort pellet-forming microorganisms for any purpose. To give but a few examples, the present disclosure is useful when it is desirable to distinguish microorganisms from one another. In some instances, the microorganisms to be distinguished may be different strains of a same species; in some instances, the microorganisms to be distinguished may represent one or more different progeny lines of the same parent exposed to at least one mutagenic protocol.

In some embodiments of the present disclosure, microorganisms that are identified, characterized, and/or isolated according to the techniques described herein are subsequently cultivated to allow production of a particular product. For example, representative commercially relevant fermentation products that may be produced by microorganisms utilized in accordance with the present disclosure include, but are not limited to, organic acids, carotenoid compounds, essential fatty acids, industrial enzymes, active pharmaceutical ingredients, extracellular carbohydrates, insecticidal compounds, etc., and combinations thereof (see discussion above).

In some embodiments, it may be desirable to identify a particular progeny microorganism that has improved production characteristics in regard to at least one commercially relevant fermentation product as compared with a parent microorganism. In some embodiments, the parent microorganism is subjected to at least one mutagenic protocol to generate progeny microorganisms; at least one sample containing at least one such progeny microorganism is subjected to analysis and/or sorting as described herein, and sorted progeny is/are used to produce a commercial product. In some embodiments, the basis for sorting is intended to reflect an improved production characteristic with regard to the commercially relevant fermentation product. It is not necessary that the basis for sorting be a direct measure of the improved production characteristic; in many embodiments, however, the sorting basis will act as a proxy for (i.e., correlate with) a desirable production characteristic of interest.

In some embodiments of the present invention, identified organisms are utilized to produce one or more commercially relevant fermentation products. In some embodiments, one or more produced compounds is/are isolated and directly used for commercial application. In some embodiments, one or more produced compounds is/are derivatized or otherwise modified before being utilized in commercial application. In some embodiments, one or more produced compounds or derivatives thereof is combined with additional ingredients or components before commercial application.

To give but a few examples, compounds and/or derivatives thereof produced by pellet-forming microorganisms as described herein may be combined with other ingredients or components to produce, for example, laundry and dishwashing detergents, foods and animal feeds, baked goods, lens cleaners, cosmetics, surfactants, solvents, fibers, flocculants for waste water treatment, gums for industrial and food applications, bacteriostatic agents in a variety of applications, soaps, shampoos, papers, and coatings, among others.

### Additional Embodiments

The methods described herein can be used to identify pellet-forming microorganisms that are characterized by a particular feature. Microorganisms can be treated to induce a phenotypic change in the cells, and progeny of the treated cells selected based on a parameter that can be correlated with the feature of interest.

In certain embodiments, the present disclosure provides a method for identifying a fungal strain having an increased capacity for organic acid biosynthesis or tolerance. The method includes, for example, providing at least one pellet-forming filamentous fungus; applying to cells of the fungus at least one treatment capable of inducing a phenotypic change in the cells, thereby forming at least one treated cell; culturing the treated cell under conditions in which a population of progeny pellets is propagated from the cell; contacting progeny pellets of the population with at least one detectable label that provides an optical signal whose magnitude is proportional to a parameter selected from the group consisting of carbohydrate uptake by, mitochondrial volume of, mitochondrial function in, and intracellular pH of the fungus, and combinations thereof, thereby forming at least one labeled pellet; detecting an optical signal from the at least one labeled pellet, thereby obtaining a test optical signal specific to the labeled pellet; comparing the test optical signal with a control optical signal produced under equivalent conditions by a control pellet of the filamentous fungus that has been contacted with the detectable label of step; identifying those pellets exhibiting a test optical signal that is different from the control optical signal; correlating the difference in optical signal with an increase in organic acid biosynthesis or tolerance (e.g., wherein the difference is a statistical average of a plurality of differences), thereby identifying at least one fungal strain having an increased capacity for organic acid biosynthesis or tolerance.

In some embodiments, the treatment to induce a phenotypic change comprises a genetic modification. In some embodiments, the organic acid is selected from the group consisting of C2-C6 mono- and di-carboxylic acids, C3-C6 tri-carboxylic acids, and combinations thereof. In some embodiments, the organic acid is selected from the group consisting of acetic, glycolic, lactic, propionic, pyruvic, butyric, hydroxybutyric, oxaloacetic, malonic, tartaric, tartronic, succinic, malic, maleic, fumaric, itaconic, citraconic, tricarballylic, isocitric, and citric acids, and combinations thereof.

In some embodiments, the parameter comprises carbohydrate uptake, and the carbohydrate is selected from the group consisting of monosaccharides, disaccharides, trisaccharides, oligosaccharides, and glycerol, and combinations thereof.

The present disclosure also features a method for identifying a fungal strain having an increased cultivatability in stirred tank reactor. The method includes, for example, providing at least one pellet-forming filamentous fungus; applying to cells of the fungus at least one treatment capable of inducing a phenotypic change in the cells, thereby forming at least one treated cell; culturing the treated cell under conditions in which a population of progeny pellets is propagated from the cell; detecting an optical signal from a progeny pellet of the population, which signal is proportional to pellet size or density, thereby obtaining a test optical signal specific to the progeny pellet; repeating the detecting to produce a set of test optical signals for progeny pellets that is representative of the population, thereby obtaining at least one test data set; providing a control data set of corresponding control optical signals produced under equivalent conditions by control pellets of the filamentous fungus of step; comparing the test data set(s) and the control data set; identifying, based on the comparison, a test data set obtained in step (e), that exhibits an improved size or an improved density relative to the control data set, thereby obtaining an improved test data set; and assigning the progeny pellet population associated with the improved test data set as a population having increased stirred-tank-reactor cultivatability, thereby identifying a fungal strain having an increased cultivatability in stirred tank reactor.

In some embodiments, the treatment comprises a genetic modification. In some embodiments, the increased cultivatability comprises increased productivity of a desired metabolite or biotransformation product, improved fermentation broth rheology, or a combination thereof.

In some embodiments, the comparing comprises first converting the optical signals to corresponding size or density values and then comparing the size or density values.

### EXEMPLIFICATION

### Example 1

### Distinguishing Strains of A. niger

Certain strains of the pellet-forming organism Aspergillus niger are known to produce citric acid. Different variants of A. niger produce citric acid at different levels, and this difference may, at least in part, be due to a difference in the extent to which they take up glucose throughout or at specific points during a fermentation.

In order to assess whether a large bore flow cytometer could be used to identify, analyze, and/or sort pellet-forming microorganisms according to the present disclosure, we prepared two different citric-acid-producing, pellet-forming strains of A. niger, related as predecessor (strain 1) and descendant (strain 2). These two strains were known to produce different levels of citric acid and also to display distinguishable glucose uptake properties (monitored through use of a fluorescent glucose analog, 2-NBDG) as measured in a fluorimeter. For example, in glucose-free shake flask medium, strain 2 pellets were more intensely stained than were strain 1 pellets.

Pellets of strain 2 and strain 1 were combined either in equal numbers or in a ratio of 1:100 (strain 2:strain 1), were exposed to 2-NBDG, were washed, were flowed through a COPAS™ Select instrument obtained from Union Biometrica (Somerville, Mass.), and were sorted onto tomato juice agar microtiter wells. Microorganisms deposited in the wells were then classified as strain 2 or strain 1 based on a phenotypic distinction: strain 1 sporulates on TJA at 33° C. in two days, yielding a distinct brown pigment, whereas the sporulation of strain 2 is delayed by 24 hours and the culture appears white after two days.

The machine was set to sort for pellets with either high (expect strain 2 isolates) or low (expect strain 1 isolates) fluorescence intensities after exposure to the 2-NBDG dye. Results are shown in Table 1 below:

TABLE 1

| Sort ratio | Expected | Actual |
|---|---|---|
| 50:50 | strain 2 | 92 white (strain 2), 1 brown (strain 1), |
| | (96 wells) | 2 misses |
| 50:50 | strain 1 | 92 brown (strain 1), 3 white, 1 mixed |
| | (96 wells) | |
| 1:100 | strain 2 | 8 white (strain 2), 2 misses |
| strain 2:strain 1 | (10) | |

These data demonstrate that a large bore flow cytometer can be utilized to sort pellet-forming microorganisms with a high degree of accuracy. Furthermore, these data demonstrate that a large bore flow cytometer can be used to sort an obligate aerobic organism (i.e., A. niger). This finding was unexpected given that it had previously been reported that the particular flow cytometer utilized in this Example, achieved only anaerobic sorting.

### Example 2

### Screening Variants of an A. niger Strain

According to the present disclosure, it is desirable to identify, analyze, and/or isolate variant A. niger strains with altered ability to produce citric acid. As demonstrated in Example 1, A. niger strains with a different ability to take up glucose can be distinguished from one another in accordance with the present disclosure by using a large bore flow cytometer that assesses fluorescence of pellet-forming microorganisms that have been exposed to NBDG.

Others have previously attempted to identify mutants of strain 2 that exhibit increased staining with NBDG and enhanced citric acid productivity. However, as demonstrated herein, sorting provides a unique advantage over traditional plate- or shake flask-based strain improvement methods in that, among other things, it is possible to examine many orders of magnitude greater number of samples in a fixed period of time. Furthermore, it may be possible to sort for multiple parameters in a given screening campaign. Screening methods were performed to identify pellets that displayed a desired fluorescent activity when stained with 2-NBDG, 6-NBDG, MitoTracker Green, or MitoTracker Red.

Spores were generated from a −80° C. 25% glycerol stock generated from a single colony of A. niger strain 2 (Tate&Lyle Ingredients North America, Decatur, Ill.); the single spore isolate of strain 2 was designated strain 2a. A small number of spores (˜10³) from the frozen stock are spread on a 100 mm or 150 mm Tomato Juice Agar (TJA) petri plate, and after 5-7 days at 33° C., the resulting spores are harvested in water and stored at 4° C. Typical spore concentrations are in the range of 10′-10⁸ per ml with 5-15 mls total volume harvested.

| Tomato Juice Agar (TJA) | | |
|---|---|---|
| Tomato juice no salt or low salt | 250 | ml |
| Deionized water | 750 | ml |
| Difco agar (Technical grade 0812-17-9) | 15 | g |
| Maltose (Difco 216830) | 20 | g |
| Pharmamedia | 10 | g |
| Antifoam | 0.1 | ml |

After the pH was adjusted to 6.85-7.15 with NaOH, the tomato juice agar was mixed and heated on a hot plate to 55°-70° C. before being autoclaved and dispensed.

A. niger strain 2a spores, as well as subsequent generations of populations of spores (e.g. spores derived from strain 3 (see below)), were mutagenized either by treatment with nitrosoguanidine (NTG), by exposure to UV irradiation, or by treatment with nitrous acid. In all cases, percent viable spores (100×[cfu/ml post-treatment÷cfu/ml pre-treatment]) were determined by serial dilutions on TJA. For NTG mutagenesis, 10⁹ spores are washed three times in 0.1M citric buffer (pH 5.5). Mutagenized spores were resuspended in citric buffer such that the spore concentration is 10⁸ spores per ml. 100 μg/ml NTG was added to the resuspended spores, and the samples were mixed and incubated at 33° C. for 1 hour. After the incubation, the spores were washed three times with 0.1 M phosphate buffer (pH 7).

For UV mutagenesis, 10⁹ spores were suspended in 50 ml water in a 150×15 mm Petri dish. The dish was place in a GS GeneLinker (BioRad, Hercules, Calif.) and exposed to UV irradiation for 1 to 10 seconds on the STR setting. Subsequent plating steps were performed in the dark to prevent photoreactivation.

Nitrous acid mutagenesis was done by inoculating 20 mls of Difco YM broth containing 0.01% Tween 80 with 2×10⁷ spores per ml. The 250 ml baffled flask was incubated at 33° C. and 225 rpm for 6 hours. After 6 hours incubation the spores were transferred to a centrifuge tube and spun down into a pellet (5 minutes at 6,000 rpm). The broth was decanted and the spores were resuspended in 20 ml of 0.1 M sodium acetate buffer. Spores were resuspended, spun down, and the buffer was decanted again.

### 0.1 M Sodium Acetate Buffer (pH 4.6)

| | | |
|---|---|---|
| Acetic acid | 3.06 | g |
| Sodium acetate | 4.02 | g |
| Tween 80 | 0.10 | ml |

The buffer was brought to 1000 ml with deionized water and the pH adjusted to between 4.55-4.65 with weak sodium hydroxide or sulfuric acid solution.

### Nitrous Acid Solution (Freshly Prepared for Each Experiment)

| | | |
|---|---|---|
| Sodium nitrite | 0.345 | g |
| 0.1M sodium acetate buffer | 100 | ml |

20 mls of fresh nitrous acid solution was added and spores were vortexed to re-suspend. Spores in nitrous acid solution were then incubated at 34° C. for one minute increments up to 1 hour. At specific times, samples of spores were removed from the flask and diluted into water and plated onto TJA to determine percent viable and also 1 ml was removed and plated onto TJA to grow and sporulate, thereby providing mutated spores for citric acid assays.

Following the various mutageneses, mutagenized spores (0.245%-14.5% viable) were either grown directly in shake flask medium (SFM), or alternatively, amplified on TJA by plating 1 ml or all of the spores from the mutagenesis onto a 150 mm TJA plate, incubating the plate at 33° C. for several days until the plated spores have grown and sporulated.

| Citric Acid Shake Flask Medium (SFM) | Recipe for 1 liter | |
|---|---|---|
| Staleydex 333 | 150-300 | g |
| CaCl₂*2H₂O | 0.037 | g |
| Stock salt solution | 10 | ml |
| Urea | 2.00 | g |
| Ammonium sulfate | 1.90 | g |
| Citric acid | 20.0 | g |
| Tween 81 | 0.45 | ml |
| pH before sterilization (with NH₄OH | 2.6-2.65 | |
| (approximately 3.9 ml of 29%) | | |
| Deionized water | to 1,000 | ml |
| 5 mg/ml Methylbenzethonium chloride (MBT) | 2 | ml |
| Flask volume | 30 | ml |

One milk filter disk/flask
Sterilize 10 min @ 121° C. on slow exhaust
Stock Salt Solution

| | | |
|---|---|---|
| MgSO₄•7H₂O | 20.3 | g |
| FeSO₄•7H₂O | 0.80 | g |
| CuSO₄•5H₂O | 3.90 | g |
| ZnSO₄•7H₂0 | 0.22 | g |
| K₂HPO₄ | 60 | g |
| Citric acid | 50 | g |
| H₂SO₄ (concentrated) | 7.5 | ml |

For the stock salt solution, after the other reagents were added, deionized water was added to 1 liter and then the solution was filter sterilized with a 0.2 micron filter.

1.2×10⁷ viable mutagenized spores were used to inoculate 30 ml aliquots of SFM in 250 ml baffled flasks capped with filter paper, and agitated (250 rpm; 2-inch throw) at 33° C. and 60% humidity for 3 to 5 days, during which time the spores germinate into ˜200 μm pellets.

Three basic staining protocols were used for most of the dyes. In the first method, the dye was added to 1 ml of pellets that had been taken from the growth flask and transferred to a 24 well plate. This staining method worked for most dyes that are not impacted by components of spent medium or the pH of the medium. Dyes for mitochondria, membrane potential, physiostatic, and some viability dyes can be used in this manner.

When the dye is an analog of a medium component, such as 2- or 6-NBDG, then the pellets are typically first rinsed free of the spent medium and placed into fresh medium lacking glucose; after this the pellets are ready for staining A more detailed protocol for this is presented in the specific example for NBDG below.

The third staining method involves addition of a dye loading aid. This method is typically employed when the dye is bulky and is more difficult to load into the pellets. One dye loading aid is Influx pinocytic cell-loading reagent (Invitrogen #I14402), which facilitates the loading of water-soluble materials into live cells via a rapid and simple technique based on the osmotic lysis of pinocytic vesicles. This loading was achieved by mixing the water-soluble dye/stain with the Influx reagent blended into growth medium, then incubating the cells in the medium to allow pinocytic uptake of the surrounding solution. When the pellets were transferred to a slightly hypotonic medium, pinocytic vesicles within the cells released the trapped material and filled the cytosol with the dye. This reagent is useful for large dyes such as dextrans and charged dyes such as pH sensors.

The useful staining concentration for each dye was empirically determined by performing a dose response curve to establish which concentration resulted in detectable staining with an optimal signal to noise ratio. Specificity of staining could be affected by a variety of parameters, including the age of the pellet and pH of the staining medium.

In order to use NBDG staining as a means to enrich for improved citric acid strains from a mutagenized population of strain 2, one ml aliquots of a 3-5 day old culture that was started from NTG mutagenized spores was placed in 15 ml SFM (lacking glucose and Tween 81; SFM-GT) and transferred to a 15 ml Isolute SPE cartridge (Biotage, LLC, Charlottesville, Va.). The pellets were washed by gentle vacuum filtration followed by resuspension in 15 ml SFM-GT and refiltration, and resuspended in 1 ml SFM-GT. Washed pellets were subsequently transferred to one well of a 24 well culture plate, to which 2-(N-(7-nitrobenz-2-oxa-1,3-diazol-4-yl)amino)-2-deoxyglucose (2-NBDG; Invitrogen, Baltimore Md.) was subsequently added, and shaken at 33° C. for 10 minutes in the dark. Stained pellets were diluted into 50 ml COPAS sheath solution (SS; Union Biometrica, Somerville, Mass.), vacuum-washed in SS once as described above and resuspended in 5 ml SS.

Stained and washed pellets were analyzed with the COPAS as described in the Union Biometrica COPAS Select Operator's Manual. Pellets that had higher incorporation of fluorescent glucose were selected by sorting for those with high fluorescence in the 545 nm channel. Pellets that met the sort criteria were deposited into 96 well plates containing TJA. The plates were incubated at 33° C. overnight. Wells that contained growing mycelia were then transferred to larger TJA plates for the generation of spores to be used for inoculation of shake flask cultures.

The spores on the TJA were harvested and used to inoculated three 250 ml flasks at 4×10⁵ spores/ml in SFM for citric acid determination. Cultures grew at 33° C. for 3 to 5 days prior to citric and glucose analysis by HPLC. Citric values were compared to the parent strain. This experiment was run with these mutants 3 or 4 times.

Tables 2 and 3 below provide a summary of a variety of sorting campaigns performed using multiple parent strains and multiple fluorescent dyes. These data demonstrate that COPAS-based sorting enables the screening of large number of samples and that dyes such as NBDG and the MitoTracker dyes (Green and Red) are useful tools for enriching for pellets with greater citric acid production potential.

TABLE 2
Fluorescent sorting for improved citric acid strains derived from strain 2a

| | | | | | # hits >3% |
|---|---|---|---|---|---|
| | Age at | | # viable | # | enhanced citric |
| | sort | | pellets | pellets | acid yield (relative |
| Sort # | (days) | Strain/mutagen/dye | sorted | screened | to strain 2) |
| 37 | 3 | strain2a/NTG/amplified/2NBDG | 24 | 38584 | 2 |
| 41 | 3 | strain2a/NTG/2NBDG | 24 | 79244 | 0 |
| 42 | 3 | strain2a/NTG/6NBDG | 20 | 118074 | 1 |
| 43 | 4 | strain2a/NTG/2NBDG | 12 | 104314 | 0 |
| 44 | 4 | strain2a/NTG/6NBDG | 17 | 145143 | 0 |
| 45 | 5 | strain2a/NTG/2NBDG | 8 | 43053 | 2 |
| 46 | 5 | strain2a/NTG/6NBDG | 10 | 78026 | 1 |
| 47 | 3 | strain2a/NTG/MTG | 42 | 47419 | 0 of 24 tested |

TABLE 3
Fluorescent sorting for improved citric acid strains derived from strain 3

| | | | | | # hits >4% | |
|---|---|---|---|---|---|---|
| | | | | | enhanced | |
| | Age at | | # viable | | citric acid | |
| | sort | | pellets | # pellets | yield (relative | # assayed |
| Sort # | (days) | Strain/mutagen/dye | sorted | screened | to strain 2) | for citric |
| 49 | <1.6 | strain 3/UV/2NBDG | 68 | 64422 | 3* | 67 |
| 50 | 2.1 | strain 3/UV/MTG | 127 | 9860 | 6+ | 127 |
| 51 | 2.1 | strain 3/UV/low MTG | 9 | NA | NA | 0 |
| 52 | 14.5 | strain 3/UV/2NBDG | 82 | 110147 | 3+ | 70 |
| 53* | 0.4 | strain 3/UV/Amplified/2NBDG | 12 | 29257 | 1 | 12 |
| 54* | 0.4 | strain 3/UV/Amplified/2NBDG | 4 | 92058 | 2 | 4 |
| 55 | 0.04 | strain 3/UV/Amplified/2NBDG | 29 | 214891 | 3* | 29 |
| 56 | 0.04 | strain 3/UV/Amplified/2NBDG/upper spur | 32 | 1204 | 2* | 22 |
| 57 | 5.20 | strain 3/UV/Amplified/MTG | 537 | 122841 | | 7 |
| 58 | 5.20 | strain 3/UV/Amplified/MTR580 | 92 | 12343 | 33* | 52 |
| 59 | 5.20 | strain 3/UV/Amplified/NBDG + MTR580 | 4 | 32020 | 0 of 3 | 4 |
| 60 | 1.04 | strain 3/UV/Amplified/MTG | ~300 | 51720 | ND | 48 |

Table 4 below shows that the mutated strains perform better for citric accumulation, yield and rate than their parent. All of these mutants were selected from the entire mutated population based on their higher fluorescence value for staining with either NBDG or a MitoTracker dye.

TABLE 4
Characterization of citric acid production from strains identified by fluorescent
sorting for NBDG or MitoTracker staining (changes reported relative to strain
2 (i.e. (value from improved strain) − (value from strain 2)))

| | | | Average increase | |
|---|---|---|---|---|
| | # times | Average increase | in yield (yield = | Average change |
| | tested (in | in accumulation | 100 * (g citric | in rate (rate = |
| | triplicate | (accumulation = | acid produced/g | g citric acid |
| Strain | cultures) | % citric acid (w/v)) | glucoseconsumed)) | per liter hour) |
| strain 4 | 5 | 1.19 | 5.24 | 0.10 |
| strain 5 | 5 | 0.72 | 5.36 | 0.06 |
| strain 6 | 6 | 2.38 | 5.52 | 0.20 |
| strain 7 | 6 | 1.41 | 4.94 | 0.12 |
| strain 8 | 6 | 1.20 | 5.01 | 0.10 |
| strain 9 | 4 | 1.48 | 5.42 | 0.13 |
| strain 10 | 3 | 2.64 | 6.95 | 0.22 |
| strain 11 | 4 | 2.24 | 6.10 | 0.19 |
| strain 12 | 4 | 1.92 | 5.39 | 0.16 |
| strain 13 | 4 | 1.65 | 5.50 | 0.14 |
| strain 3 | 10 | 0.93 | 1.84 | 0.04 |

As described above, mutant strains were also identified based on increased optical density of pellets after growth in medium containing a non-glucose carbon source. Mutated spores were grown in SFM containing the alternative carbon source instead of glucose for three days. After three days the pellets were rinsed with SS and analyzed with the COPAS™. The pellets were sorted for a specified large time of flight (size), not too large to include clumps, and medium optical density.

Pellets that met the sort criteria were deposited into 96 well plates containing TJA. The plates were incubated at 33° C. overnight. Wells that contained growing mycelia were then transferred to larger TJA plates for the generation of spores. The spores on the TJA were harvested and used to inoculate three 250 ml flasks at 4×10⁵ spores/ml in SF for citric acid determination. Cultures grew at 33° C. for 3 to 5 days prior to citric and glucose analysis by HPLC. Citric acid values were compared to the parent strain. The mutant microorganism that produced denser cell pellets when grown on the alternative carbon source was re-grown and assayed for its ability to produce citric acid; it was found to show consistent improvement in citric acid production when grown on either the alternative carbon source or on glucose.

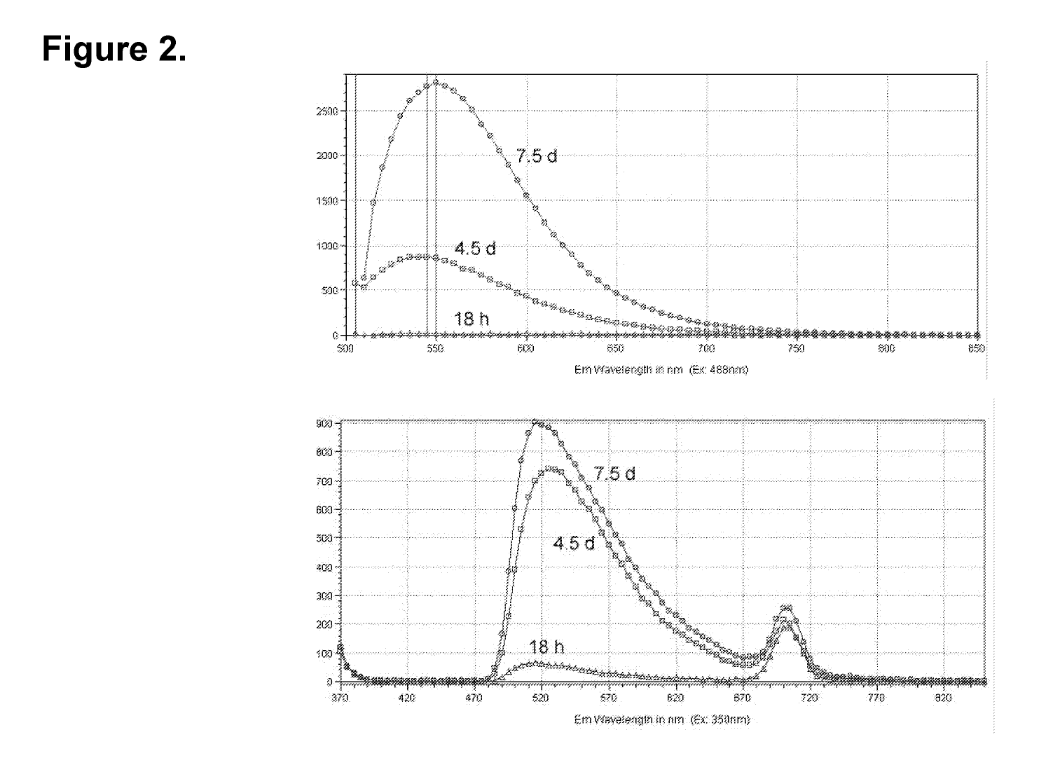

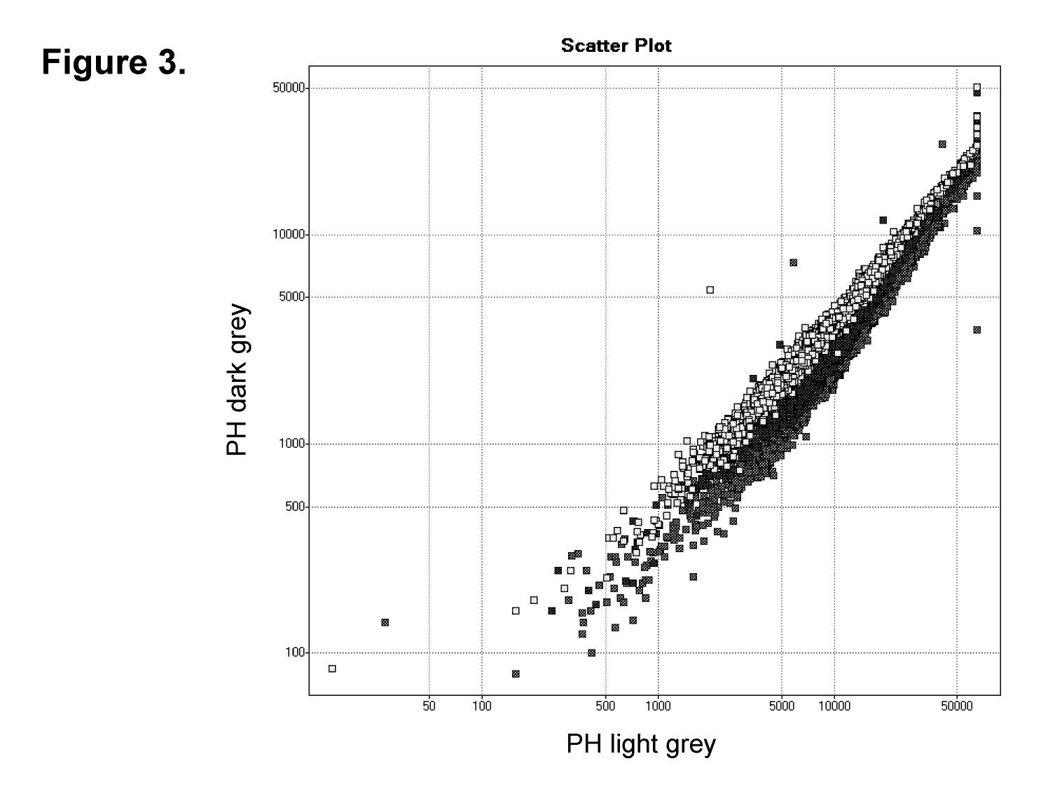

Additional screening criteria can be used to select pellet-forming microorganisms with desired properties. For example, the autofluorescence of the pellet can be a facile and useful primary or secondary screening parameter. Autofluorescence is a broad-spectrum natural fluorescence that is present in most fluorescent channels. It is caused by endogenous molecules that absorb light in many regions of the near ultraviolet and visible light spectrum. Autofluorescence of the pellets was examined for strain 2 at three ages. FIG. 2 depicts the spectra of pellets excited at either 350 or 488 nm in a fluorimeter, and confirms that changes in autofluorescence over time can be detected. Age-dependent autofluorescence of strain 2 was also examined with the COPAS. Three cultures of strain 2 were initiated at 24 hour intervals and observed together at effectively 2, 3, and 4 days after inoculation. As seen in FIG. 3, the use of a red/yellow sorting axis (peak height (PH) for red fluorescence was detected at 610 nm, PH for red fluorescence was detected at 545 nm; shown in dark grey/light grey, respectively, in FIG. 3) allows one to clearly distinguish the three ages despite significant overlap. While the source of this phenomenon is not known, it provides an example of the process of correlating fluorescent signatures with important fermentation states. One can imagine a selection where a pellet from a late, less productive stage of fermentation is chosen due to its possession of a signature associated with an earlier productive phase.

Mutants were identified that at 5 days old have the autofluorescence characteristics of two-day-old pellets, more yellow fluorescence, less red. Pellets were sorted from 5 day old NTG strain 2 mutant pellets. The sort was designed to select for pellets that were more yellow than most of the mutant population or more red than most of the mutant population (a negative control). For this experiment the pellets were deposited in a batch of 20-100 on a small TJA plate and allowed to grow and sporulate. Once sporulation occurred the spores were harvested, inoculated, grown for 3 days, and retested in the COPAS to determine if they still maintained the characteristic for which they were selected. In general, the pool of pellets that were selected to have the younger, more yellow autofluorescent signature maintained that phenotype when re-grown. The pellets that were selected for a more red phenotype also maintained that phenotype when re-grown.

Furthermore, additional fluorescent dyes can be employed. For instance, the SNARF series of dyes provides a means to identify pellets with a desired range of intracellular pH. SNARF dyes can be used to identify citric acid producing strains that are capable of maintaining an intracellular pH within a certain range, even in the presence of high concentrations of citric acid and low pH broth conditions (e.g. pH 2.0). These strategies, as well as others described herein, will be useful.

These data therefore demonstrate that the present disclosure can be utilized to identify, analyze, and sort pellet-forming microorganisms from a genetically diverse mixture, and specifically illustrates identification and isolation of pellet-forming microorganisms with in creased ability to produce a particular commercial product (i.e., citric acid).

### EQUIVALENTS

Those skilled in the art will recognize, or be able to ascertain using no more than routine experimentation, many equivalents to the specific embodiments of the disclosure, described herein. The scope of the present disclosure is not intended to be limited to the above Description, but rather is as set forth in the appended claims.

In the claims articles such as “a,” “an,” and “the” may mean one or more than one unless indicated to the contrary or otherwise evident from the context. Claims or descriptions that include “or” between one or more members of a group are considered satisfied if one, more than one, or all of the group members are present in, employed in, or otherwise relevant to a given product or process unless indicated to the contrary or otherwise evident from the context.

The disclosure includes embodiments in which exactly one member of the group is present in, employed in, or otherwise relevant to a given product or process. The disclosure includes embodiments in which more than one, or all of the group members are present in, employed in, or otherwise relevant to a given product or process. Furthermore, it is to be understood that the disclosure encompasses all variations, combinations, and permutations in which one or more limitations, elements, clauses, descriptive terms, etc., from one or more of the listed claims is introduced into another claim. For example, any claim that is dependent on another claim can be modified to include one or more limitations found in any other claim that is dependent on the same base claim. Furthermore, where the claims recite a composition, it is to be understood that methods of using the composition for any of the purposes disclosed herein are included, and methods of making the composition according to any of the methods of making disclosed herein or other methods known in the art are included, unless otherwise indicated or unless it would be evident to one of ordinary skill in the art that a contradiction or inconsistency would arise.

Where elements are presented as lists, e.g., in Markush group format, it is to be understood that each subgroup of the elements is also disclosed, and any element(s) can be removed from the group. It should it be understood that, in general, where the disclosure, or aspects of the disclosure, is/are referred to as comprising particular elements, features, etc., certain embodiments of the disclosure or aspects of the disclosure consist, or consist essentially of, such elements, features, etc. For purposes of simplicity those embodiments have not been specifically set forth in haec verba herein.

It is noted that the term “comprising” is intended to be open and permits the inclusion of additional elements or steps.

Where ranges are given, endpoints are included. Furthermore, it is to be understood that unless otherwise indicated or otherwise evident from the context and understanding of one of ordinary skill in the art, values that are expressed as ranges can assume any specific value or subrange within the stated ranges in different embodiments of the disclosure, to the tenth of the unit of the lower limit of the range, unless the context clearly dictates otherwise.

In addition, it is to be understood that any particular embodiment of the present disclosure that falls within the prior art may be explicitly excluded from any one or more of the claims. Since such embodiments are deemed to be known to one of ordinary skill in the art, they may be excluded even if the exclusion is not set forth explicitly herein. Any particular embodiment of the compositions of the disclosure can be excluded from any one or more claims, for any reason, whether or not related to the existence of prior art.

The publications discussed above and throughout the text are provided solely for their disclosure prior to the filing date of the present application. Nothing herein is to be construed as an admission that the inventors are not entitled to antedate such disclosure by virtue of prior disclosure.

What is claimed is:

1. A method comprising steps of:
a. obtaining a sample containing genetically diverse microorganisms in pellet form;
b. detecting one or more optically detectable parameters of individual pellets within the sample; and
c. sorting individual pellets into separate containers based on the detected one or more parameters.

2. (canceled)

3. (canceled)

4. The method of claim 1, wherein the sample containing genetically diverse microorganisms in pellet form comprises microorganisms related as progeny of a parent microorganism, which progeny were generated through application of a mutagenic protocol.

5. The method of claim 1, wherein the sample containing genetically diverse microorganisms comprises microorganisms related to the natural heterogeneity found within a parent microorganism.

6. (canceled)

7. (canceled)

8. The method of claim 1, wherein the optically detectable parameter is selected from the group consisting of size of the microorganism pellets, optical density of the microorganism pellets, intensities of one or more fluorescent emissions, and combinations thereof.

9. The method of claim 8, wherein one of said fluorescent emissions is autofluorescence of the pelleted microorganism.

10. The method of claim 8, wherein one of said fluorescent emissions quantifies a fluorescent dye present in or on certain individual pellets.

11. The method of claim 10, wherein the fluorescent dye is an analog or derivative of a carbohydrate used for the cultivation of pellet-forming microorganisms.

12. The method of claim 11, wherein the analog or derivative of a carbohydrate is an analog or derivative of glucose.

13. The method of claim 12, wherein the analog or derivative of glucose is either 2-NBDG or 6-NBDG.

14. The method of claim 10, wherein the fluorescent dye is an indicator of viability of pellet-forming microorganisms, intracellular pH in a pellet-forming microorganism, mitochondrial size or activity in a pellet-forming microorganism, intracellular lipid or polydroxyalkanoate level, extracellular carbohydrate levels, or cytoplasmic membrane potential.

15. The method of claim 14, wherein the indicator of viability is FUN1, propidium iodide, trypan blue, neutral red, resazurin or acridine orange, the indicator of the intracellular pH is SNAFL, SNARF 4F or SNARF 5F, the indicator of the mitochondrial size or activity is rhodamine 123, rhodamine B hexyl ester, MitoTracker Green, MitoTracker Red or SYTO 18, indicator of intracellular lipid or polydroxyalkanoate level is nile red, the indicator of extracellular carbohydrate levels is calcofluor, concanavalin A, or fluorescent conjugates of wheat germ agglutinin, and the indicator of cytoplasmic membrane potential is DiOC₆ or bis-(1,3-dibutylbarbituric acid)trimethine oxonol.

16. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. The method of claim 1, wherein the microorganism is a filamentous fungus.

30. (canceled)

31. The method of claim 29, wherein the filamentous fungus is of the genus Aspergillus, Emericella, Penicillium, Acremonium, Mortierella, Trichoderma, Fusarium, Paecilomyces, Rhizopus, Blakeslea, Mucor, or Phycomyces.

32. The method of claim 31, wherein the filamentous fungus is Aspergillus niger, Aspergillus terreus, Rhizopus oryzae, Mortierella alpine, Trichoderma reesei or Paecilomyces sp.

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. A method comprising steps of:
a. obtaining a sample containing genetically diverse pellet-forming microorganisms;
b. culturing the sample so that microorganisms adopt their pellet form;
c. detecting one or more optically detectable parameters of individual microorganism pellets within the sample;
d. sorting individual microorganism pellets into separate containers based on the one or more optically detectable parameters; and
e. cultivating at least one of the sorted individual microorganism pellets under conditions that allow it to produce a predetermined product.

55. (canceled)

56. (canceled)

57. The method of claim 54, wherein the sample containing genetically diverse pellet-forming microorganisms comprises microorganisms related as progeny of a parent microorganism, which progeny were generated through application of a mutagenic protocol.

58. The method of claim 57 wherein the parent microorganism produces the predetermined product.

59. The method of claim 57 wherein the parent microorganism does not produce the predetermined product.

60. The method of claim 54 wherein the at least one sorted individual microorganism pellet differs from the parent in its production of the predetermined product.

61. The method of claim 60 wherein the at least one sorted individual microorganism pellet produces more of the predetermined product than does the parent microorganism under identical fermentation conditions.

62. (canceled)

63. A sorted and cultivated pellet-forming microorganism obtained by a method comprising steps of:
a. obtaining a sample containing genetically diverse pellet-forming microorganisms;
b. culturing the sample so that microorganisms adopt their pellet form;
c. detecting one or more optically detectable parameters of individual microorganism pellets within the sample;
d. sorting individual microorganism pellets into separate containers based on the one or more optically detectable parameters; and
c. cultivating at least one of the sorted individual microorganism pellets under conditions that allow it to produce a predetermined product.

64. The sorted and cultivated pellet-forming microorganism of claim 63, wherein the microorganism produces a predetermined product.

65. The sorted and cultivated pellet-forming microorganism of claim 64, wherein the sample comprises progeny of a parent wherein the parent does not produce the predetermined product.

66. The sorted and cultivated pellet-forming microorganism of claim 64 wherein the microorganism pellet differs from the parent in its production of the predetermined product.

67. The sorted and cultivated pellet-forming microorganism of claim 66 wherein the microorganism pellet produces more of the predetermined product than does the parent microorganism under identical fermentation conditions.

68. (canceled)

69. A process for identifying a fungal strain having an increased capacity for organic acid biosynthesis or tolerance, comprising:
a. providing at least one pellet-forming filamentous fungus;
b. applying to cells of the fungus at least one treatment capable of inducing a phenotypic change in the cells, thereby forming at least one treated cell;
c. culturing the treated cell under conditions in which a population of progeny pellets is propagated from the cell;
d. contacting progeny pellets of the population with at least one detectable label that provides an optical signal whose magnitude is proportional to a parameter selected from the group consisting of carbohydrate uptake by, mitochondrial volume of, mitochondrial function in, and intracellular pH of the fungus, and combinations thereof, thereby forming at least one labeled pellet;
e. detecting an optical signal from the at least one labeled pellet, thereby obtaining a test optical signal specific to the labeled pellet;
f. comparing the test optical signal with a control optical signal produced under equivalent conditions by a control pellet of the filamentous fungus of step (a) that has been contacted with the detectable label of step (d);
g. identifying those pellets exhibiting a test optical signal that is different from the control optical signal;
h. correlating the difference in optical signal with an increase in organic acid biosynthesis or tolerance, thereby identifying at least one fungal strain having an increased capacity for organic acid biosynthesis or tolerance.

70. The process according to claim 69, wherein the treatment of step (b) comprises a genetic modification.

71. The process according to claim 69, wherein the organic acid is selected from the group consisting of C2-C6 mono- and di-carboxylic acids, C3-C6 tri-carboxylic acids, and combinations thereof.

72. The process according to claim 69, wherein the organic acid is selected from the group consisting of acetic, glycolic, lactic, propionic, pyruvic, butyric, hydroxybutyric, oxaloacetic, malonic, tartaric, tartronic, succinic, malic, maleic, fumaric, itaconic, citraconic, tricarballylic, isocitric, and citric acids, and combinations thereof.

73. The process according to claim 69, wherein the parameter of step (d) comprises carbohydrate uptake, and wherein the carbohydrate is selected from the group consisting of monosaccharides, disaccharides, trisaccharides, oligosaccharides, and glycerol, and combinations thereof.

74. The process according to claim 69, wherein the difference in step (h) is a statistical average of a plurality of differences identified in step (g).

75. (canceled)

76. (canceled)

77. (canceled)

78. (canceled)

79. The method of claim 1 further comprising using the microorganisms of at least one sorted pellet to biomanufacture a compound.

80. The method of claim 79 wherein the compound is an organic acid.

81. The method of claim 80 wherein the organic acid is selected from the group consisting of citric acid, lactic acid, malic acid, succinic acid, itaconic acid, tartaric acid, fumaric acid, derivatives thereof, and combinations thereof.

82. The method of claim 80 wherein the organic acid is citric acid.
